(19) United States
(12) Patent Application Publication
(10) Pub. No.: US 2021/0197969 A1
(43) Pub. Date: Jul. 1, 2021

(54) DIAPHRAGM PUMP AND AGRICULTURAL UNMANNED AERIAL VEHICLE

(71) Applicant: SZ DJI SOFTWARE TECHNOLOGY CO., LTD., Shenzhen (CN)

(72) Inventors: Zhan SHU, Shenzhen (CN); Xiaolong WU, Shenzhen (CN); Daoyu WAN, Shenzhen (CN)

(21) Appl. No.: 17/198,219

(22) Filed: Mar. 10, 2021

Related U.S. Application Data
(63) Continuation of application No. PCT/CN2018/109096, filed on Sep. 30, 2018.

(51) Int. Cl. B64D 1/18; F04B 43/04; B64C 39/02

(52) U.S. Cl. CPC B64D 1/18; F04B 43/04; B64C 2201/128; B64C 2201/027; B64C 39/024

(57) ABSTRACT

A diaphragm pump includes a pump body mechanism, a one-way valve mechanism, a diaphragm mechanism, a motor mechanism, and an eccentric mechanism. The one-way valve mechanism includes a one-way valve and a valve cover configured to mount the one-way valve at the pump body mechanism. The diaphragm mechanism includes a pump cover mounted at the pump body mechanism and a diaphragm connected to the pump cover. The pump cover is configured to cover the diaphragm and the valve cover. The one-way valve mechanism, the diaphragm mechanism, the motor mechanism, and the eccentric mechanism are mounted at the pump body mechanism.

### CROSS-REFERENCE TO RELATED APPLICATION

This application is a continuation of International Application No. PCT/CN2018/109096, filed Sep. 30, 2018, the entire content of which is incorporated herein by reference.

### TECHNICAL FIELD

This disclosure relates to the technical field of driving devices and, in particular to a diaphragm pump and an agricultural unmanned aerial vehicle.

### TECHNICAL BACKGROUND

At present, diaphragm pumps have been widely used in the plant protection industry in recent years because of their good corrosion resistance. A diaphragm pump includes multiple components. However, the structure of the existing plant protection diaphragm pump generally does not consider the mechanism layout, such that after the diaphragm of the diaphragm pump is damaged or the eccentric cam is worn, it is difficult to disassemble the diaphragm pump for maintenance. Due to the non-mechanism design of the structure, the diaphragm pump is often scrapped due to the damage of a certain component, causing huge economic losses. In addition, the one-way valve of the existing diaphragm pump is generally mounted at the diaphragm, or mounted at a pump chamber together with the diaphragm, such that the one-way valve also needs to be removed when the diaphragm is removed. Components of the one-way valve are relatively small parts, which are easy to lose, causing inconvenience.

### SUMMARY

The present disclosure provides a diaphragm pump and an agricultural unmanned aerial vehicle.

A diaphragm pump of an embodiment of the present disclosure includes a pump body mechanism, a one-way valve mechanism, a diaphragm mechanism, a motor mechanism, and an eccentric mechanism. The one-way valve mechanism includes a one-way valve and a valve cover configured to mount the one-way valve at the pump body mechanism. The diaphragm mechanism includes a pump cover mounted at the pump body mechanism and a diaphragm connected to the pump cover. The pump cover is configured to cover the diaphragm and the valve cover. The one-way valve mechanism, the diaphragm mechanism, the motor mechanism, and the eccentric mechanism are mounted at the pump body mechanism.

In the above diaphragm pump, each mechanism can be individually designed to minimize mechanism dependence and facilitate maintenance. The valve cover fixes the one-way valve to the pump body mechanism. Also, when the pump cover is opened, the one-way valve can still be mounted at the pump body mechanism via the valve cover, and the one-way valve does not fall off. The valve cover needs to be removed before the one-way valve can be removed, and when the diaphragm is being removed, the one-way valve is not removed, avoiding the risk of losing the one-way valve parts.

An agricultural unmanned aerial vehicle of an embodiment of the present disclosure includes a vehicle body, a liquid storage tank for storing liquid chemicals, a spray assembly, and a diaphragm pump. The diaphragm pump includes a pump body mechanism, a one-way valve mechanism, a diaphragm mechanism, a motor mechanism, and an eccentric mechanism. The one-way valve mechanism includes a one-way valve and a valve cover configured to mount the one-way valve at the pump body mechanism. The diaphragm mechanism includes a pump cover mounted at the pump body mechanism and a diaphragm connected to the pump cover. The pump cover is configured to cover the diaphragm and the valve cover. The one-way valve mechanism, the diaphragm mechanism, the motor mechanism, and the eccentric mechanism are mounted at the pump body mechanism.

In the above agricultural unmanned aerial vehicle, each mechanism can be individually designed to minimize mechanism dependence and facilitate maintenance. The valve cover fixes the one-way valve to the pump body mechanism. Also, when the pump cover is opened, the one-way valve can still be mounted at the pump body mechanism by the valve cover, and the one-way valve does not fall off. The valve cover needs to be removed before the one-way valve can be removed, and when the diaphragm is being removed, the one-way valve is not removed, avoiding the risk of losing the one-way valve parts.

Additional aspects and advantages of the embodiments of the present disclosure will be partially given in the following description, and some will become obvious from the following description, or be understood through implementations of the present disclosure.

### BRIEF DESCRIPTION OF THE DRAWINGS

The above and/or additional aspects and advantages of the present disclosure will become obvious and easy to understand from the description of the embodiments in conjunction with the following drawings, in which:

FIG. 1 is a perspective view of an agricultural unmanned aerial vehicle according to an embodiment of the present disclosure;

FIG. 2 is a perspective view of a diaphragm pump according to an embodiment of the present disclosure;

FIG. 3 is a perspective partially exploded view of a diaphragm pump according to an embodiment of the present disclosure;

FIG. 4 is another perspective partially exploded view of a diaphragm pump according to an embodiment of the present disclosure;

FIG. 5 is a cross-sectional view of a diaphragm pump according to an embodiment of the present disclosure;

FIG. 6 is an enlarged view of part 1 of the diaphragm pump of FIG. 5;

FIG. 7 is another cross-sectional view of a diaphragm pump according to an embodiment of the present disclosure;

FIG. 8 is a perspective view of a part of a diaphragm pump according to an embodiment of the present disclosure;

FIG. 9 is a perspective partially exploded view of a diaphragm pump according to an embodiment of the present disclosure;

FIG. 10 is another perspective partially exploded view of a diaphragm pump according to an embodiment of the present disclosure;

FIG. 11 is a cross-sectional view of a part of a diaphragm pump according to an embodiment of the present disclosure;

FIG. 12 is a perspective view of a pump body mechanism of a diaphragm pump according to an embodiment of the present disclosure;

FIG. 13 is a perspective view of a pump cover of a diaphragm pump according to an embodiment of the present disclosure;

FIG. 14 is a perspective view of a bracket assembly and a diaphragm of a diaphragm pump according to an embodiment of the present disclosure;

FIG. 15 is a plan view of a bracket assembly and a diaphragm of a diaphragm pump according to an embodiment of the present disclosure;

FIG. 16 is a perspective partially exploded view of a bracket assembly and a diaphragm of a diaphragm pump according to an embodiment of the present disclosure;

FIG. 17 is a cross-sectional view of a bracket assembly and a diaphragm of a diaphragm pump according to an embodiment of the present disclosure;

FIG. 18 is a perspective view of an auxiliary member of a diaphragm pump according to an embodiment of the present disclosure;

FIG. 19 is a perspective view of a motor mechanism of a diaphragm pump according to an embodiment of the present disclosure;

FIG. 20 is a perspective exploded view of a motor mechanism of a diaphragm pump according to an embodiment of the present disclosure; and

FIG. 21 is a cross-sectional view of a motor mechanism of a diaphragm pump according to an embodiment of the present disclosure.

### DESCRIPTION OF REFERENCE NUMERALS FOR MAIN COMPONENTS

Agricultural unmanned aerial vehicle 1000;

Diaphragm pump 100;

Pump body mechanism 10, First fixing member 101, Second fixing member 102, Pump body 11, First mounting surface 111, Second mounting surface 112, Accommodating cavity 113, First mounting groove 114, Bottom surface 1141, Mounting cavity 1140, Groove 115, Liquid inlet 116, Liquid outlet 117, One-way valve mechanism 20, One-way valve 21, First one-way valve 211, Second one-way valve 212, Valve seat 213, Valve core 214, Elastic member 215, First positioning column 216, Second positioning column 217, Valve cover 22, Valve cover cavity 221, Valve-cover inflow channel 222, Valve-cover outflow channel 223, Diaphragm mechanism 30, Pump cover 31, Diaphragm cavity 310, First cavity 311, Second cavity 312, Flow channel 313, Opening 3131, Circulation chamber 314, Diaphragm 32, Connection member 321, Connection portion 322, Plug 33, Motor mechanism 40, Motor 41, Motor body 411, Convex member 4111, Motor shaft 412, Eccentric shaft member 413, Housing 42, Second mounting groove 421, Eccentric mechanism 50, Bracket assembly 51, Bracket 511, Driving member 512, Support member 513, Block 5131, Auxiliary member 52, First slot 521, Second slot 522, Contact surface 523, Support bearing 60, Plug mechanism 70, Plug body 71, Terminal 72;

Vehicle body 200, Liquid storage tank 300, Spray assembly 400, Arm 500, and Standing support 600.

### DETAILED DESCRIPTION OF THE EMBODIMENTS

The embodiments of the present disclosure are described in detail below. Examples of the embodiments are shown in the accompanying drawings, where the same or similar reference numerals indicate the same or similar elements or elements with the same or similar functions. The following embodiments described with reference to the accompanying drawings are exemplary, and are only used to explain the present disclosure, and should not be understood as a limitation to the present disclosure.

In the description of the present disclosure, it should be understood that the terms “center,” “longitudinal,” “transverse,” “length,” “width,” “thickness,” “upper,” “lower,” “front,” “back,” “left,” “right,” “vertical,” “horizontal,” “top,” “bottom,” “inner,” “outer,” “clockwise,” “counterclockwise,” and other directions or positional relationships are based on the orientation or positional relationship shown in the drawings, are only for the convenience of describing the application and simplifying the description, and do not indicate or imply that the device or element referred to must have a specific orientation, be constructed, and operated in a specific orientation. Therefore, they cannot be understood as a restriction on the present disclosure. In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include one or more of the features. In the description of the present disclosure, “multiple” means two or more than two, unless otherwise specifically defined.

In the description of the present disclosure, it should be noted that the terms “mounting,” “connection,” and “coupling” should be interpreted broadly unless otherwise clearly specified and limited. For example, it can be a fixed connection, a detachable connection, or an integrated connection. It can be a mechanical connection or an electrical connection. It can be direct connection, or indirect connection through an intermediate medium, and it can be a communication between two elements or an interaction relationship between two elements. For those of ordinary skill in the art, the specific meanings of the above terms in the present disclosure can be understood according to specific circumstances.

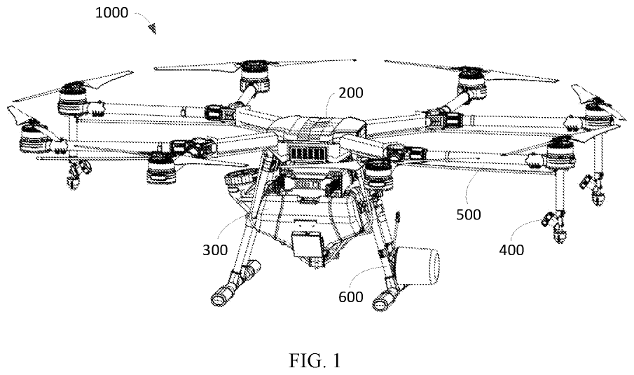

Referring to FIG. 1, a diaphragm pump 100 of the embodiments of the present disclosure is applied to an agricultural unmanned aerial vehicle 1000 or another spraying device, so as to provide spraying driving force for the agricultural unmanned aerial vehicle 1000 or the other spraying device. An embodiment of the present disclosure is further described by taking the diaphragm pump 100 applied to the agricultural unmanned aerial vehicle 1000 as an example.

Referring to FIG. 1, the agricultural unmanned aerial vehicle 1000 includes a vehicle body 200, a liquid storage tank 300 for storing liquid chemicals, a spraying assembly 400, and an arm 500. The diaphragm pump 100 communicates with the liquid storage tank 300 and the spray assembly 400 through a pipe. The diaphragm pump 100 is used to pump liquid from the liquid storage tank 300 to the spray assembly 400 for irrigation.

It should be noted that the method of mounting the diaphragm pump 100 at the agricultural unmanned aerial vehicle 1000 can be set according to the specific application environment. For example, the diaphragm pump 100 can be mounted at the vehicle body 200 as shown in FIG. 1. The method of mounting the liquid storage tank 300 at the agricultural unmanned aerial vehicle 1000 is also not specifically limited. For example, the liquid storage tank 300 can be fixed at the standing support 600 of the agricultural unmanned aerial vehicle 1000 by fixing parts such as screws. The method of mounting the spraying assembly 400 at the agricultural unmanned aerial vehicle 1000 is also not specifically limited. For example, the spraying assembly 400 can be fixed to the vehicle body 200 by snap connection or screw connection or other fixing methods. In the example shown in FIG. 1, the spray assembly 400 is provided at a side of the arm 500 away from the vehicle body 200. The spray assembly 400 includes a spray head (not shown in the drawings). The spray assembly 400 sprays liquid through a spray head for irrigation.

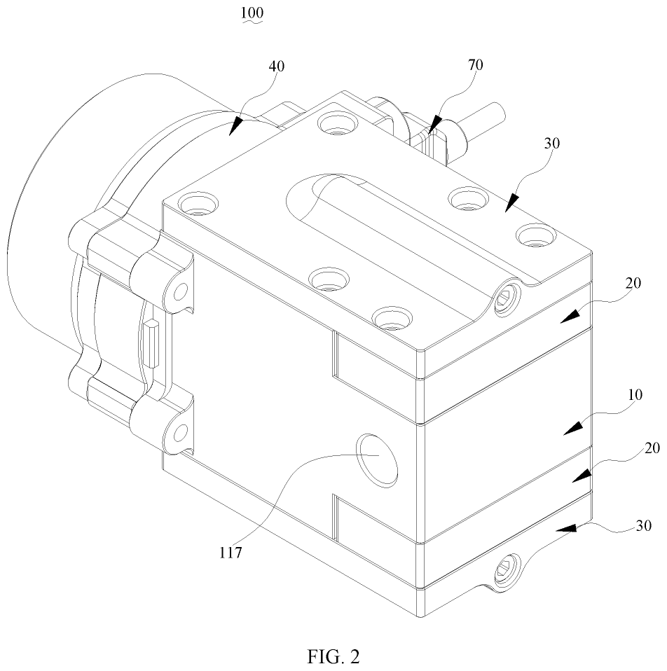

Referring to FIGS. 2-4, the diaphragm pump 100 of this embodiment includes a pump body mechanism 10, a one-way valve mechanism 20, a diaphragm mechanism 30, a motor mechanism 40, an eccentric mechanism 50, a support bearing 60, and a plug mechanism 70. The one-way valve mechanism 20, the diaphragm mechanism 30, the motor mechanism 40, the eccentric mechanism 50, and the plug mechanism 70 are mounted at the pump body mechanism 10. The support bearing 60 is supported in the pump body mechanism 10. In this embodiment, the plug mechanism 70 is attached to the pump body mechanism 10 via the motor mechanism 40. The plug mechanism 70 is electrically connected to the motor mechanism 40.

It should be noted that in this embodiment, the number of the one-way valve mechanism 20 is two. The two one-way valve mechanisms 20 have the same structure. The embodiments of the present disclosure will take one of the one-way valve mechanisms 20 as an example for description. The number of the diaphragm mechanism 30 is two. The two diaphragm mechanisms 30 have the same structure. The embodiments of the present disclosure will take one of the diaphragm mechanisms 30 as an example for description.

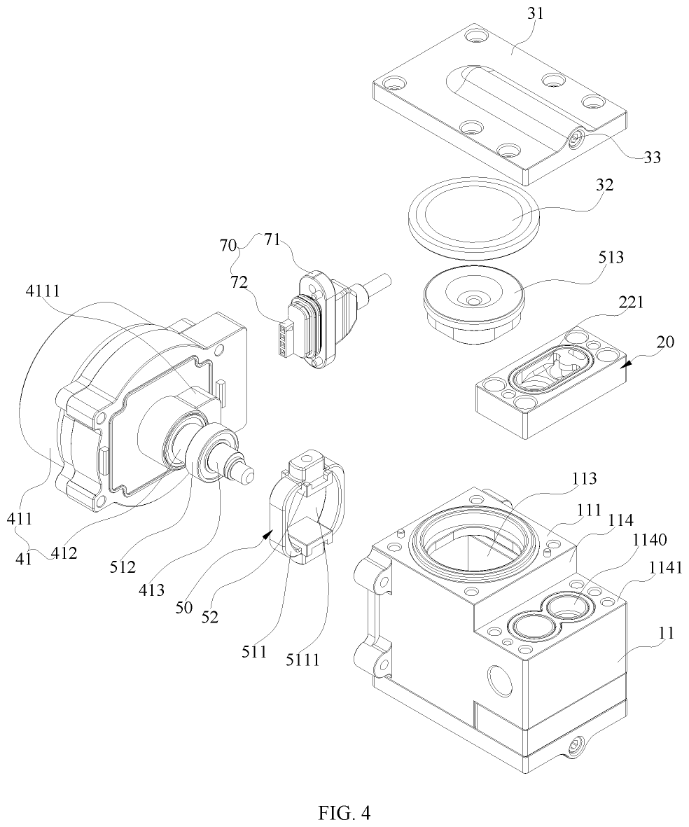

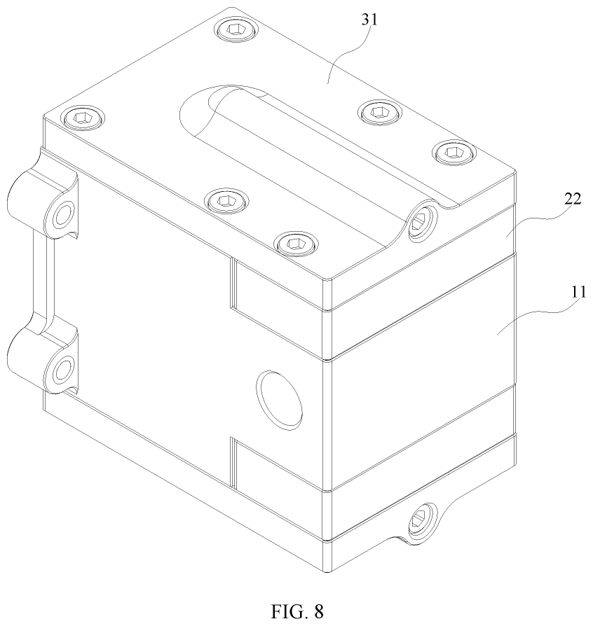

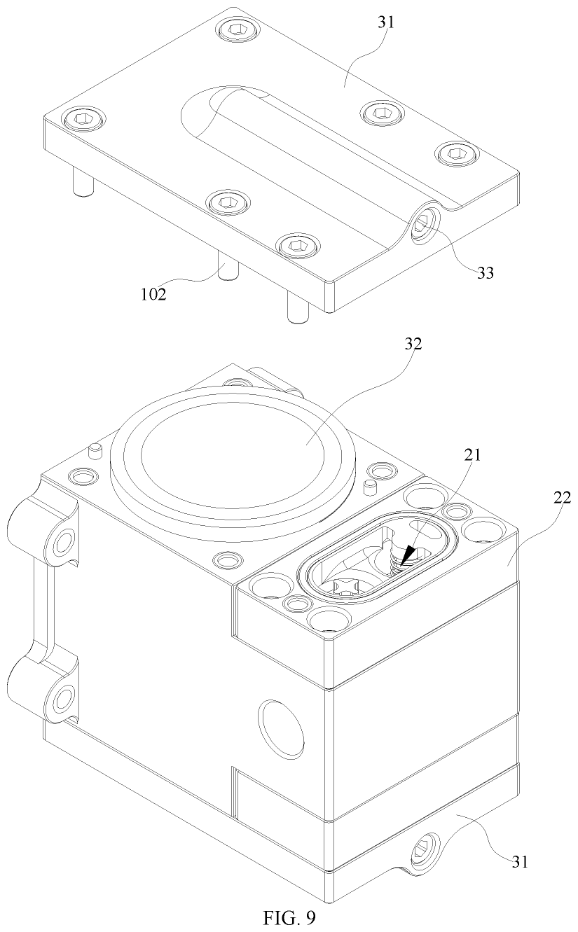

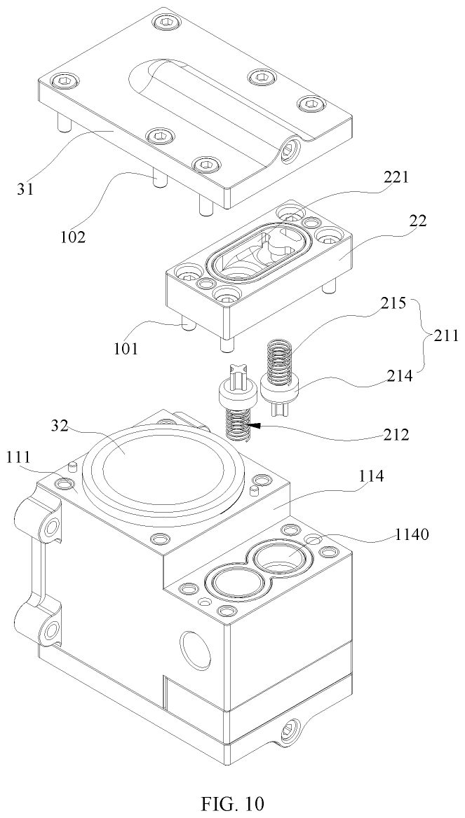

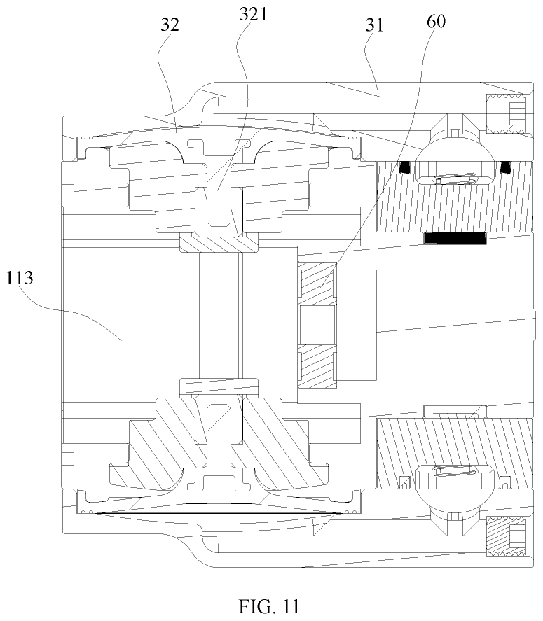

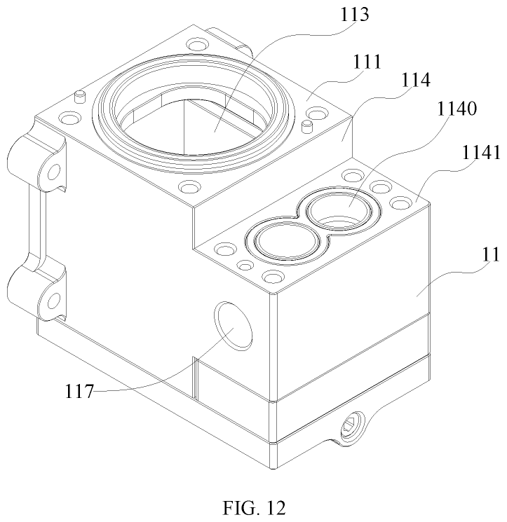

Referring to FIGS. 4 to 5 and FIGS. 8 to 12, the pump body mechanism 10 includes a pump body 11. The pump body 11 has a substantially rectangular shape. Opposite ends of the pump body 11 are each formed with a first mounting surface 111. A second mounting surface 112 is formed at another end of the pump body 11. The second mounting surface 112 is located between the two first mounting surfaces 111. The pump body 11 is configured with an accommodating cavity 113 penetrating through the two first mounting surfaces 111. Each of the first mounting surface 111 is configured with a first mounting groove 114. The eccentric mechanism 50 and the support bearing 60 are arranged in the accommodating cavity 113. The one-way valve mechanism 20 is mounted at the first mounting groove 114. One of the diaphragm mechanisms 30 is mounted at a corresponding first mounting surface 111 and covers a corresponding one-way valve mechanism 20.

Each of the diaphragm mechanisms 30 is at least partially accommodated in the accommodating cavity 113, which facilitates the mounting and disassembly of the diaphragm mechanism 30 and facilitates the individual design of each mechanism. Two mounting cavities 1140 are disposed at a bottom surface 1141 of each of the first mounting grooves 114. The one-way valve mechanism 20 is partially mounted at the two mounting cavities 1140. The configuration of the mounting cavity 1140 can improve the mounting stability of the one-way valve mechanism 20.

The second mounting surface 112 is configured with a groove 115. The groove 115 communicates with the accommodating cavity 113. The groove 115 can be used to position a mounting direction of the motor mechanism to realize a foolproof function.

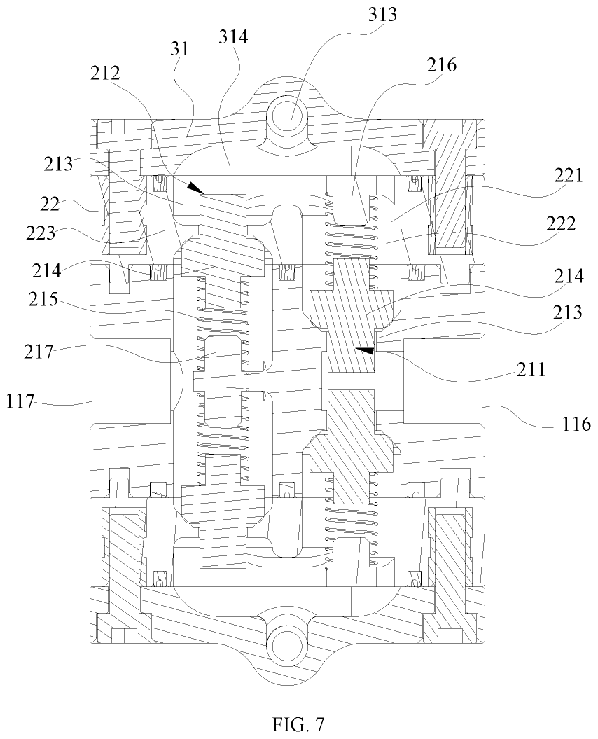

Referring to FIGS. 2 and 7, the pump body 11 is provided with a liquid inlet 116 and a liquid outlet 117. When the diaphragm pump 100 is working, liquid can enter the diaphragm pump 100 through the liquid inlet 116 and can flow out of the diaphragm pump 100 through the liquid outlet 117. In this embodiment, the liquid inlet 116 and the liquid outlet 117 are provided at two opposite sides of the pump body 11, respectively. In the orientation of FIG. 7, the liquid inlet 116 and the liquid outlet 117 are provided at the left and right sides of the pump body 11, respectively. The liquid inlet 116 can communicate with the liquid storage tank 300, and the liquid outlet 117 can communicate with the spray assembly 400.

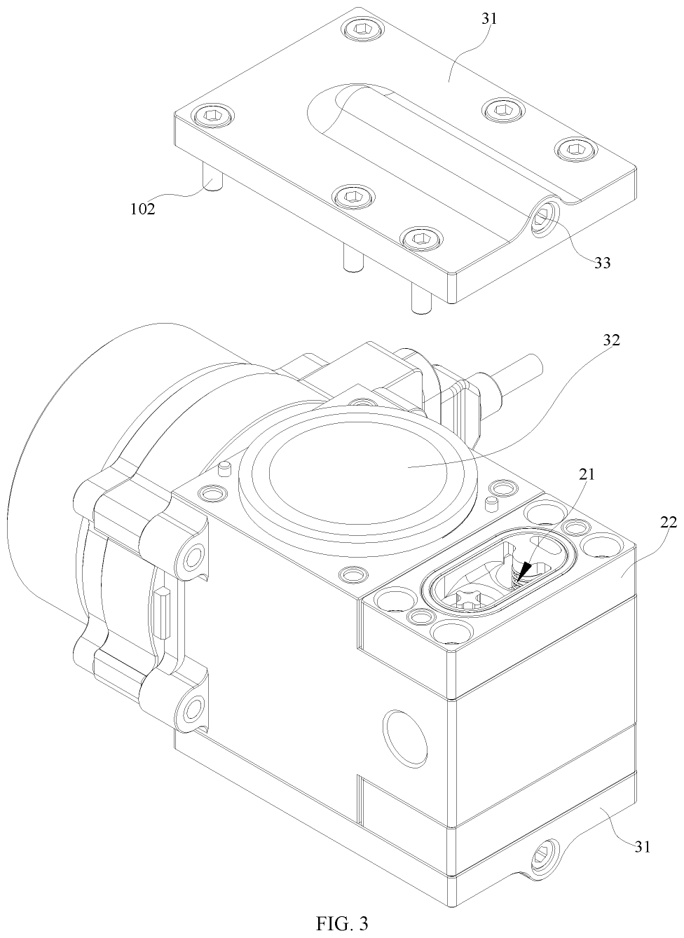

Referring to FIGS. 3 and 4, the one-way valve mechanism 20 includes a one-way valve 21 and a valve cover 22. The valve cover 22 mounts the one-way valve 21 at the pump body mechanism 10. In some embodiments, the valve cover 22 mounts the one-way valve 21 in the first mounting groove 114. It can be understood that, in order to improve the mounting stability of the one-way valve mechanism 20, a shape of the valve cover 22 can be matched with a shape of the first mounting groove 114.

It can be understood that the valve cover 22 can be fixed to the pump body 11 via a first fixing member 101, where the first fixing member 101 may be, e.g., a screw. As such, fixing the valve cover 22 to the pump body 11 via the first fixing member 101 can also realize independent fixing of the one-way valve mechanism 20.

Referring to FIG. 7, the one-way valve 21 includes a first one-way valve 211 and a second one-way valve 212. The valve cover 22 is provided with a valve cover cavity 221. The valve cover cavity 221 is provided with a valve-cover inflow channel 222 and a valve-cover outflow channel 223. The first one-way valve 211 is used to control the opening and closing of the valve-cover inflow channel 222. The second one-way valve 212 is used to control the opening and closing of the valve-cover outflow channel 223. The one-way valve mechanism 20 is configured as that when the first one-way valve 211 opens the valve-cover inflow channel 222, the second one-way valve 212 closes the valve-cover outflow channel 223, and when the second one-way valve 212 opens the valve-cover outflow channel 223, the first one-way valve 211 closes the valve-cover inflow channel 222. In this way, the one-way valve 21 can control the flow of liquid into or out of the valve cover cavity 221. It should be noted that both the first one-way valve 211 and the second one-way valve 212 can make the liquid flow in one direction along a preset direction.

In this embodiment, when the first one-way valve 211 opens the valve-cover inflow channel 222, the liquid inlet 116 communicates with the valve-cover inflow channel 222, and liquid can enter the valve-cover inflow channel 222 through the liquid inlet 116. When the first one-way valve 211 closes the valve-cover inflow channel 222, the liquid inlet 116 does not communicate the valve-cover inflow channel 222, and the liquid cannot enter the valve-cover inflow channel 222 through the liquid inlet 116. When the second one-way valve 212 opens the valve-cover outflow channel 223, the liquid outlet 117 communicates with the valve-cover outflow channel 223, and the liquid in the valve-cover outflow channel 223 can flow out of the diaphragm pump 100 through the liquid outlet 117. When the second one-way valve 212 closes the valve-cover outflow channel 223, the liquid outlet 117 does not communicate with the valve-cover outflow channel 223, and the liquid in the valve-cover outflow channel 223 cannot flow out of the diaphragm pump 100 through the liquid outlet 117.

In order to improve the stability of the liquid flow, each of the first one-way valve 211 and the second one-way valve 212 includes a valve seat 213, a valve core 214 mounted at the valve seat 213, and an elastic member 215 matched with the valve core 214. The mounting directions of the valve core 214 of the first one-way valve 211 and the second one-way valve 212 are opposite to each other. In order to facilitate the control of the liquid flow, the valve seat 213 of the first one-way valve 211 is provided in the pump body mechanism 10, and the valve seat 213 of the second one-way valve 212 is provided in the valve cover cavity 221.

It should be noted that the elastic member 215 may be, e.g., a spring. One end of the elastic member 215 sleeves the valve seat 213, and the other end sleeves the core 214, so that the valve core 214 can reciprocate stably following the elastic member 215.

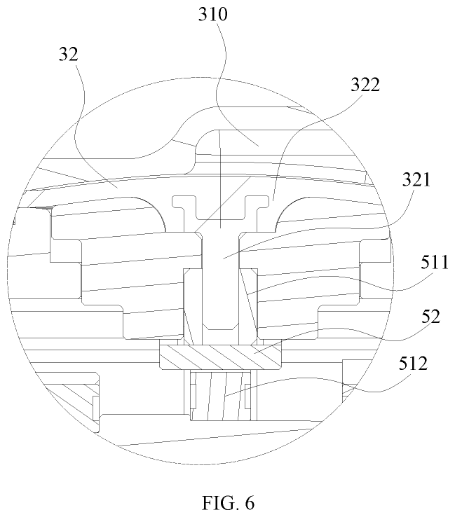

In the example shown in FIG. 7, in order to improve the operating stability of the elastic member 215, the inner wall of the valve cover cavity 221 is protrudingly provided with a first positioning column 216 for positioning the elastic member 215 of the first one-way valve 211. The pump mechanism 10 is provided with a second positioning column 217 for positioning the elastic member 215 of the second one-way valve 212. Referring to FIGS. 3-6, the diaphragm mechanism 30 includes a pump cover 31, a diaphragm 32 connected to the pump cover 31, and a plug 33. The pump cover 31 and the diaphragm 32 together form a diaphragm cavity 310. In this embodiment, each pump cover 31 and a corresponding diaphragm 32 together form a diaphragm cavity 310. That is, the number of diaphragm cavities 310 is two.

The pump cover 31 is mounted at the pump body mechanism 10 and covers the diaphragm 32 and the valve cover 22. In some embodiments, the diaphragm 32 is disposed in the accommodating cavity 113. The pump cover 31 is mounted at the first mounting surface 111 and covers the diaphragm 32 and the valve cover 22. As such, each mechanism can be individually designed to minimize mechanism dependence and facilitate maintenance. The valve cover 22 fixes the one-way valve 21 to the pump body mechanism 10. Also, when the pump cover 31 is opened, the one-way valve 21 can still be mounted at the pump body mechanism 10 by the valve cover 22, and the one-way valve 21 does not fall off. The valve cover 22 needs to be removed before the one-way valve 21 can be removed. When the diaphragm 32 is being removed, the one-way valve 21 will not be removed, which avoids the risk of losing the parts of the one-way valve 21.

It can be understood that the pump cover 31 can be fixed at the pump body 11 via the second fixing member 102, where the second fixing member 102 may be, e.g., a screw. In this way, when the pump cover 31 needs to be removed, the pump cover 31 can be removed only by unscrewing the second fixing member 102, and then the diaphragm 32 can be removed. When the pump cover 31 is removed, the one-way valve mechanism 20 is still separately and fixedly mounted at the pump body 11 by the first fixing member 101 and will not fall off. The first fixing member 101 needs to be removed before the one-way valve 21 can be removed.

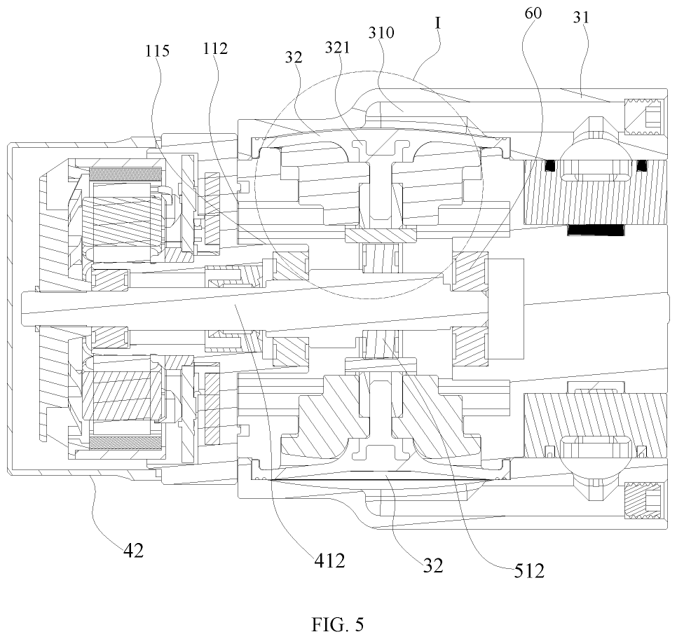

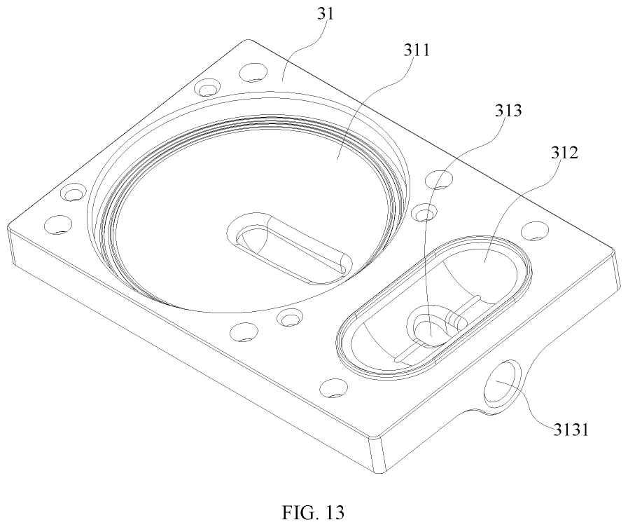

Referring to FIG. 13, the pump cover 31 is provided with a first cavity 311, a second cavity 312, and a flow channel 313 connecting the first cavity 311 and the second cavity 312. The valve cover cavity 221 and the second cavity 312 are correspondingly connected to form a circulation chamber 314. The diaphragm 32 seals the first cavity 311 to form a diaphragm cavity 310, and the flow channel 313 communicates with the circulation chamber 314 and the diaphragm cavity 310. It can be understood that, in the embodiment of the present disclosure, a single pump cover 31 opens a single flow channel 313. In this way, a single flow channel 313 is used to communicate between the diaphragm cavity 310 and the one-way valve mechanism 20, which can reduce the complexity and manufacturing cost of the diaphragm pump 100, and also reduce the liquid flow resistance. In the example shown in FIGS. 5 and 13, the pump cover 31 has a substantially rectangular parallelepiped shape. The flow channel 313 is opened at an inner side of the pump cover 31. The flow channel 313 communicates with the diaphragm cavity 310. The liquid flows into or out of the diaphragm cavity 310 through the flow channel 313. The liquid entering the valve-cover inflow channel 222 from the liquid inlet 116 can enter the diaphragm cavity 310 via the flow channel 313. The liquid in the diaphragm cavity 310 can enter the valve-cover outflow channel 223 via the flow channel 313 and exit the diaphragm pump 100 via the liquid outlet 117.

The flow channel 313 has an opening 3131 formed at a side surface of the pump cover 31. The plug 33 is arranged in the flow channel 313 and blocks the opening 3131. In this way, the setting of the plug 33 can effectively prevent the liquid from flowing out of the opening 3131. For example, the plug 33 can be detachably mounted at the flow channel 313. When the flow channel 313 needs to be cleaned, only the plug 33 only needs to be opened without disassembling the entire pump cover 31, which saves maintenance cost and time. In an example, the plug 33 is provided in the flow channel 313 by a screw connection.

The diaphragm 32 is detachably connected to the eccentric mechanism 50. As such, the one-way valve mechanism 20 is designed independently from the diaphragm mechanism 30 to ensure that the one-way valve mechanism 20 is not affected when the diaphragm 32 is removed, which simplifies the replacement operation of the diaphragm 32 and avoids the risk of missing parts of the one-way valve 21. The diaphragm 32 is connected to the pump body mechanism 10 through a connection member 321. In some embodiments, the surface of the diaphragm 32 is provided with a connection portion 322. The head of the connection member 321 is provided at the connection portion 322. In this way, the connection between the diaphragm 32 and the connection member 321 can have better stability.

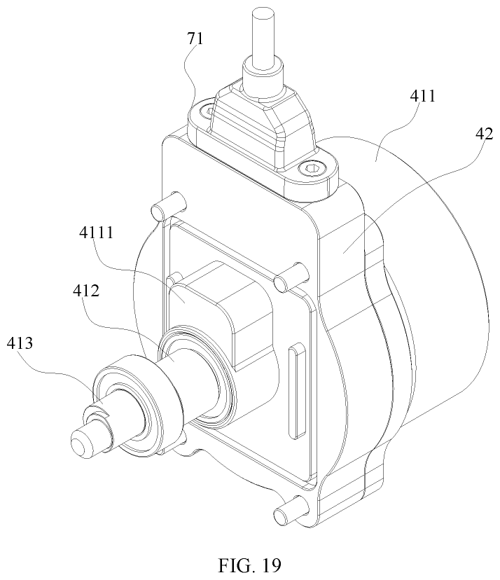

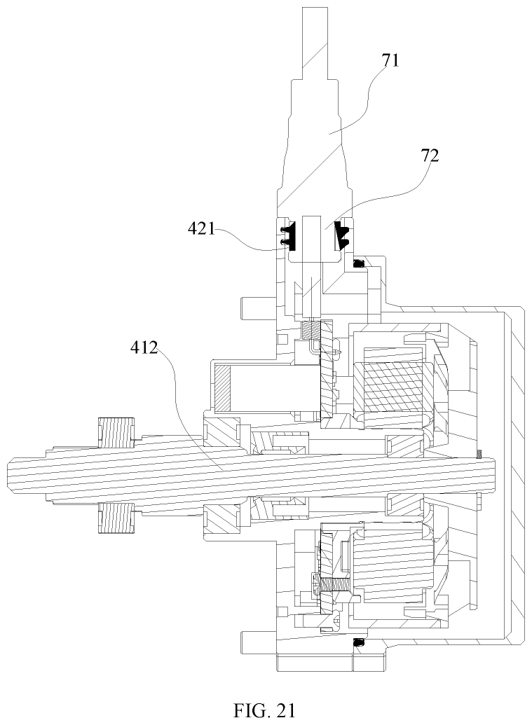

Referring to FIGS. 19-21, the motor mechanism 40 includes a motor 41, a housing 42, and a cover 43. The motor 41 includes a motor body 411 and a motor shaft 412. The motor shaft 412 is connected to the motor body 411. The motor shaft 412 of the motor 41 includes an eccentric shaft member 413. The eccentric shaft member 413 is connected to the eccentric mechanism 50. The motor 41 is used to drive the motor shaft 412 to drive the diaphragm 32 to reciprocate through the eccentric mechanism 50 to increase or decrease the volume of the diaphragm cavity 310. In this way, when the volume of the diaphragm cavity 310 is reduced, the liquid in the diaphragm cavity 310 can be squeezed to flow out through the flow channel 313, and enter the circulation chamber 314, and open the valve-cover outflow channel 223 at the second one-way valve 212. When the volume of the diaphragm cavity 310 increases, the diaphragm cavity 310 can suck the liquid in the circulation chamber 314 into the diaphragm cavity 310 through the flow channel 313.

It can be understood that the arrangement of the eccentric shaft member 413 enables the power of the motor 41 to be transmitted to the eccentric shaft member 413, which reduces transmission loss. It should be noted that the eccentric shaft member 413 can be disposed at the motor shaft 412 in an integrated manner to form an eccentric shaft, which can avoid the problem of weakening the strength of keyslots on the motor shaft 412 or edge trimming.

Referring to FIG. 5, the surface of the motor body 411 facing the pump body mechanism 10 is provided with a convex member 4111. The convex member 4111 is accommodated in the groove 115. The eccentric shaft member 413 is rotatably accommodated in the accommodation cavity 113. The cooperating arrangement of the convex member 4111 and the groove 115 can position the mounting direction of the motor mechanism 40 to the pump body mechanism 10 and realize a foolproof function. Furthermore, a support bearing 60 is mounted at one end of the motor shaft 412 away from the motor body 411. The support bearing 60 is disposed in the accommodating cavity 113 and can improve the stability of the motor shaft 412 when it rotates.

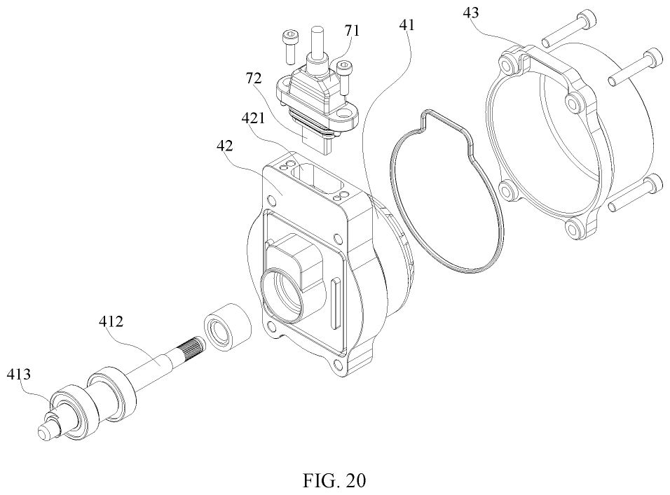

Referring to FIG. 20, the housing 42 is provided with a second mounting groove 421. The plug mechanism 70 includes a plug body 71 and a terminal 72 connected to the plug body 71. The terminal 72 can be detachably mounted at the second mounting groove 421 so that the plug mechanism 70 is mounted at the housing 42, which facilitates the mounting and removal of the plug mechanism 70. The motor 41 is housed in the cover 43.

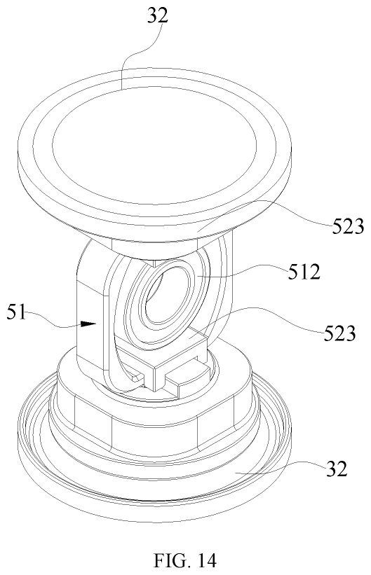

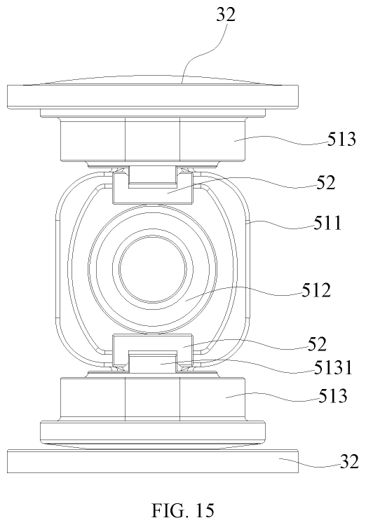

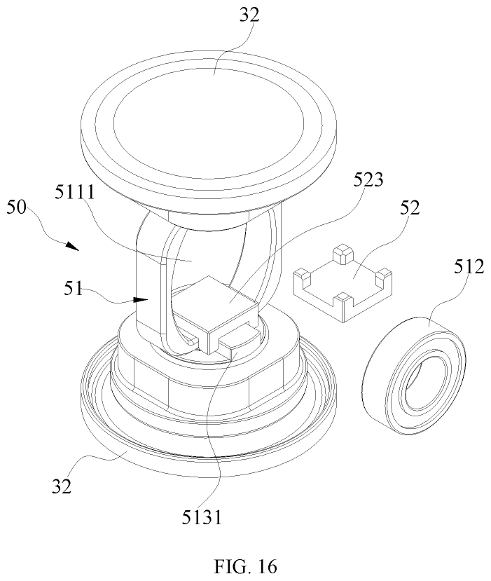

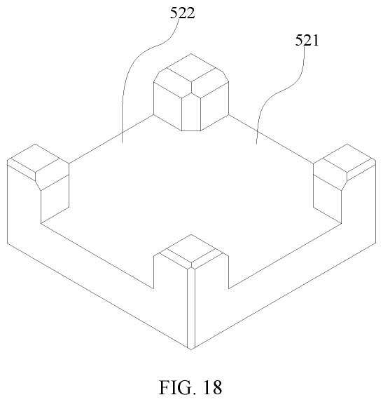

Referring to FIGS. 14 to 18, the eccentric mechanism 50 includes a bracket assembly 51 and an auxiliary member 52. The eccentric shaft member 413 is rotatably sleeved by the bracket assembly 51. The bracket assembly 51 is connected to the diaphragm 32. In this way, the rotation of the eccentric shaft member 413 can drive the bracket assembly 51 to reciprocate to drive the diaphragm 32 to reciprocate, so as to increase or decrease the volume of the diaphragm cavity 310.

The bracket assembly 51 includes a bracket 511, a driving member 512, and a support member 513. The bracket 511 is connected to the diaphragm 32. The bracket 511 has a frame shape. The bracket 511 is provided with a mounting through hole 5111. The auxiliary member 52 can be detachably mounted at the bracket 511 through a snap structure, which facilitates the disassembly of the auxiliary member 52 and enables quick replacement. The diaphragm 32 is supported at the bracket 511 by the support 513, so that the diaphragm 32 can have better stability during reciprocating motion.

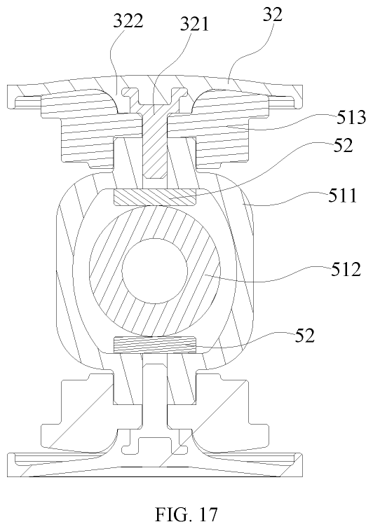

Referring to FIG. 5 and FIG. 17, in this embodiment, the number of the support member 513 is two. Two support members 513 are arranged at opposite ends of the bracket 511. The two diaphragms 32 are disposed at the two support members 513, respectively. The two diaphragms 32 are symmetrically arranged with respect to the bracket 511. One of the two support members 513 is arranged between the diaphragm 32 of one diaphragm mechanism 30 and the bracket 511 to support the corresponding one of the diaphragm 32, and the other is arranged between the diaphragm 32 of the other diaphragm mechanism 30 and the bracket 511 to support the other corresponding diaphragm 32. The rotation of eccentric shaft member 413 can drive the bracket assembly 51 to reciprocate to drive the two diaphragms 32 to reciprocate, so as to increase or decrease the volume of the corresponding diaphragm cavity 310.

Here, the diaphragm 32 is connected to the bracket 511 through the connection member 321. It should be noted that the connection member 321 may be, e.g., a screw. One end of the connection member 321 may be insert-molded with the diaphragm 32, and the other end thereof may be screwed to the bracket 511 to achieve a fixed connection.

The driving member 512 is mounted at the eccentric shaft member 413. The auxiliary member 52 is provided between the driving member 512 and the side wall of the mounting through hole 5111. The auxiliary member 52 is arranged corresponding to the driving member 512. The auxiliary member 52 is used to contact the driving member 512. When the motor 41 is working, the eccentric shaft member 413 drives the driving member 512 to move, so that the driving member 512 reciprocally abuts against the auxiliary member 52, and the bracket 511 moves together with the auxiliary member 52, such that the bracket 511 drives the diaphragm 32 to reciprocate. As such, the wear problem of the eccentric mechanism 50 is solved by adding the auxiliary member 52. When the diaphragm pump 100 is running, the auxiliary member 52 is worn without damaging or reducing damage to the driving member 512 and the bracket 511, which improves the service life and reliability of the diaphragm pump 100.

The surface of the auxiliary member 52 facing away from the driving member 512 is provided with a first slot 521 and a second slot 522. A frame of the bracket 511 is locked in the first slot 521. The support member 513 is convexly provided with a block 5131. The block 5131 is locked in the second slot 522. In this way, the auxiliary member 52 is detachably mounted at the bracket 511 through a snap structure, and the stability of the auxiliary member 52 in the axial and radial direction can be ensured.

It can be understood that the driving member 512 may be, e.g., a bearing. In this way, the driving member 512 can have a better stability.

It is understandable that in other embodiments, the motor shaft may not be provided with an eccentric shaft member, and the driving member is directly sleeved on the motor shaft, and an eccentric protrusion is formed at the driving member, so that the driving member can reciprocally abuts against the auxiliary member. For example, the driving member may be an eccentric bearing sleeved on the motor shaft. When the motor shaft rotates, the eccentric bearing makes an eccentric movement, thereby driving the bracket assembly to reciprocate to drive the diaphragm 32 to reciprocate.

In the example shown in FIG. 17, the number of auxiliary members 52 is two. The two auxiliary members 52 are symmetrically mounted at two opposite side walls of the mounting through hole 5111, respectively. The driving member 512 is located between the two auxiliary members 52, so as to better prevent wear. Each auxiliary member 52 is formed with a contact surface 523 for contact with the driving member 512. The surface of the auxiliary member 52 facing away from the driving member 512 is opposite to the contact surface 523. The formation of the contact surface 523 can increase the contact area between the auxiliary member 52 and the driving member 512 and improve the stability of the driving member 512 for reciprocally abutting against the auxiliary member 52.

It should be noted that the auxiliary member 52 may be, e.g., a gasket. The auxiliary member 52 can be made of wear-resistant plastic (such as nylon or polyacetal plastic, etc.) or bronze. In order to facilitate the mounting and disassembly of the auxiliary member 52, the whole auxiliary member 52 can be made into a square snap shape, that is, the auxiliary member 52 is mounted at the bracket 511 by a snap structure. When the motor mechanism 40 is removed, the eccentric shaft member 413 is disengaged, and then the auxiliary member 52 can be removed for quick replacement.

Referring to FIG. 5, in this embodiment, the rotating eccentric shaft member 413 can drive the bracket assembly 51 to reciprocate to drive the two diaphragms 32 to reciprocate to move closer to or away from the corresponding pump cover 31, so that the volumes of two diaphragm changes in the opposite direction. In this embodiment, the two diaphragms 32 are located at opposite sides, the upper side and the lower side of the bracket assembly 51 as shown in FIG. 5. When the motor 41 is working, the two diaphragms 32 move in the same direction. While squeezing the diaphragm 32 on the upper side to move upward, the bracket assembly 51 can also stretch the diaphragm 32 on the lower side to move upward. At this time, the squeezed upper diaphragm 32 moves toward the pump cover 31 on the upper side, and the stretched lower diaphragm 32 moves away from the pump cover 31 on the lower side, so that the volume of the upper diaphragm cavity 310 formed by the squeezed diaphragm 32 and the upper pump cover 31 decreases, while the volume of the lower diaphragm cavity 310 formed by the stretched diaphragm 32 and the lower pump cover 31 increases. Referring to FIG. 7 again, when the volume of the upper diaphragm chamber 310 increases, liquid is sucked from the liquid storage tank 300 through the flow channel 313 and the circulation chamber 314, the first one-way valve 211 opens the valve-cover inflow channel 222, and the second one-way valve 212 closes the valve-cover outflow channel 223. When the volume of the upper diaphragm chamber 310 decreases, the liquid is discharged to the spray assembly 400 through the flow channel 313 and the circulation chamber 314, the second one-way valve 212 opens the valve-cover outflow channel 223, and the first one-way valve 211 closes the valve-cover inflow channel 222. Similarly, when the volume of the lower diaphragm cavity 310 decreases or increases, the same liquid discharge and suction process is performed. The differences are that when the upper diaphragm cavity 310 sucks liquid, the lower diaphragm cavity 310 discharges liquid, and when the lower diaphragm cavity 310 sucks liquid, the upper diaphragm cavity 310 discharges the liquid. In this way, the liquid can flow out of the flow channel 313 from the diaphragm cavity 310 with a reduced volume to be sprayed through the spray assembly 400, and the liquid can be sucked into the diaphragm cavity 310 with an increased volume to achieve the suction of the liquid by the diaphragm pump 100.

In summary, the above-described diaphragm pump 100 includes a pump body mechanism 10, a one-way valve mechanism 20, a diaphragm mechanism 30, a motor mechanism 40 and an eccentric mechanism 50. The one-way valve mechanism 20, the diaphragm mechanism 30, the motor mechanism 40, and the eccentric mechanism 50 are mounted at the pump body mechanism 10. The diaphragm mechanism 30 includes a pump cover 31 and a diaphragm 32 connected to the pump cover 31. The one-way valve mechanism 20 includes a one-way valve 21 and a valve cover 22. The valve cover 22 mounts the one-way valve 21 at the pump body mechanism 10. The pump cover 31 is mounted at the pump body mechanism 10 and covers the diaphragm 32 and the valve cover 22.

In the above-described diaphragm pump 100, each mechanism can be individually designed to minimize mechanism dependence and facilitate maintenance. The valve cover 22 fixes the one-way valve 21 to the pump body mechanism 10. Also, when the pump cover 31 is opened, the one-way valve 21 can still be mounted at the pump body mechanism 10 by the valve cover 22, and the one-way valve 21 will not fall off. The valve cover 22 needs to be removed before the one-way valve 21 can be removed, and when the diaphragm 32 is being removed, the one-way valve 21 will not be removed, which avoids the risk of losing the parts of the one-way valve 21.

In the present disclosure, unless expressly stipulated and defined otherwise, the first feature being “on” or “under” the second feature may include the first and second features being in direct contact, or may include the first and second features not being in direct contact but through other features between them. Moreover, the first feature being “above,” “over,” and “on” the second feature include the first feature being directly above and obliquely above the second feature, or it simply means that the level of the first feature is higher than the second feature. The first feature being “below,” “under” and “beneath” the second feature include the first feature being directly below and obliquely below the second feature, or it simply means that the level of the first feature is lower than the second feature.

The above disclosure provides many different embodiments or examples to realize the different structures of the present disclosure. In order to simplify the disclosure of the present disclosure, the components and settings of the examples are described above. Of course, they are only examples and are not intended to limit the present disclosure. In addition, the present disclosure may repeat reference numerals and/or reference letters in different examples. Such repetition is for the purpose of simplification and clarity, and does not indicate the relationship between the various embodiments and/or settings discussed. In addition, the present disclosure provides examples of various processes and materials, but those of ordinary skill in the art may be aware of the application of other processes and/or the use of other materials.

In the description of this specification, the description with reference to the terms “an embodiment,” “some embodiments,” “exemplary embodiments,” “examples,” “specific examples,” or “some examples,” etc., means that combinations of the specific features, structures, materials, or characteristics described by the embodiments or the examples may be included in at least one embodiment or example of the present disclosure. In this specification, the schematic representations of the above terms do not necessarily refer to the same embodiment or example. Moreover, the described specific features, structures, materials, or characteristics can be combined in an appropriate manner in any one or more embodiments or examples.

Although the embodiments of the present disclosure have been shown and described, those of ordinary skill in the art can understand that various changes, modifications, substitutions, and variants can be made to these embodiments without departing from the principle and purpose of the present disclosure. The scope of the invention is defined by the claims and their equivalents.

What is claimed is:

1. A diaphragm pump comprising:
a pump body mechanism;
a one-way valve mechanism including a one-way valve and a valve cover configured to mount the one-way valve at the pump body mechanism;
a diaphragm mechanism including a pump cover mounted at the pump body mechanism and a diaphragm connected to the pump cover, the pump cover being configured to cover the diaphragm and the valve cover;
a motor mechanism; and
an eccentric mechanism;
wherein the one-way valve mechanism, the diaphragm mechanism, the motor mechanism, and the eccentric mechanism are mounted at the pump body mechanism.

2. The diaphragm pump according to claim 1, further comprising:
a diaphragm cavity surrounded by the diaphragm and the pump cover;
wherein the motor mechanism includes:
a motor shaft including an eccentric shaft member connected to the eccentric mechanism; and
a motor configured to drive the motor shaft to drive the diaphragm to reciprocate through the eccentric mechanism, so as to increase or decrease a volume of the diaphragm cavity.

3. The diaphragm pump according to claim 2, wherein:
the motor includes a motor body connected to the motor shaft;
the motor body includes a convex member disposed at a surface of the motor body facing the pump body mechanism; and
a side surface of the pump body mechanism includes a groove configured to accommodate the convex member.

4. The diaphragm pump according to claim 2, wherein the eccentric mechanism includes a bracket assembly connected to the diagram, the eccentric shaft member being rotatably sleeved by the bracket assembly.

5. The diaphragm pump according to claim 4, wherein:
the bracket assembly includes a bracket connected to the diaphragm and a driving member mounted at the eccentric shaft member;
the eccentric mechanism includes an auxiliary member arranged corresponding to the driving member and configured to contact the driving member; and
when the motor is working:
the eccentric shaft member drives the driving member to move, to cause the driving member to reciprocally abut against the auxiliary member; and
the bracket moves together with the auxiliary member and drives the diaphragm to reciprocate.

6. The diaphragm pump according to claim 5, wherein the bracket assembly includes a support member, and the diaphragm is supported at the bracket through the support member.

7. The diaphragm pump according to claim 5, wherein the auxiliary member is detachably mounted at the bracket through a snap structure.

8. The diaphragm pump according to claim 5, wherein:
a surface of the auxiliary member facing away from the driving member includes a first groove and a second groove;
the bracket includes a frame snapped in the first groove; and
the support member includes a block protruding from a surface of the support member and being snapped in the second groove.

9. The diaphragm pump according to claim 5, wherein the diaphragm is connected to the bracket through a connection member.

10. The diaphragm pump according to claim 2, further comprising:
a support bearing disposed at the pump body mechanism;
wherein:
the motor further includes a motor body connected to the motor shaft;
the support bearing mounted at one end of the motor shaft away from the motor body.

11. The diaphragm pump according to claim 1, further comprising:
a plug mechanism mounted at the motor mechanism and being electrically connected to the motor mechanism.

12. The diaphragm pump according to claim 1, wherein:
the pump cover includes a first cavity, a second cavity, and a flow channel connecting the first cavity and the second cavity;
the valve cover includes a valve cover cavity connected with the second cavity, the valve cavity and the second cavity forming a circulation chamber; and
the diaphragm is configured to seals the first cavity to form a diaphragm cavity.

13. The diaphragm pump according to claim 12, wherein the pump cover is one of a plurality of pump covers of the diaphragm pump, each of the plurality of pump covers including a flow channel.

14. The diaphragm pump according to claim 12, wherein:
an opening of the flow channel is disposed at one side of the pump cover; and
the diaphragm mechanism includes a plug arranged in the flow channel and configured to block the opening.

15. The diaphragm pump according to claim 1, wherein:
the valve cover includes a valve cover cavity, the valve cover cavity including a valve-cover inflow channel and a valve-cover outflow channel; and
the one-way valve includes:
a first one-way valve configured to control opening and closing of the valve-cover inflow channel; and
a second one-way valve configured to control opening and closing of the valve-cover outflow channel.

16. The diaphragm pump according to claim 15, wherein:
the second one-way valve is configured to close the valve-cover outflow channel when the first one-way valve opens the valve-cover inflow channel; and
the first one-way valve is configured to close the valve-cover inflow channel when the second one-way valve opens the valve-cover outflow channel.

17. The diaphragm pump according to claim 15, wherein:
each of the first one-way valve and the second one-way valve includes:
a valve seat;
a valve core mounted at the valve seat; and
an elastic member matched with the valve core;
wherein the valve core of the first one-way valve and the valve core of the second one-way valve are mounted in opposite directions.

18. The diaphragm pump according to claim 17, wherein:
the valve seat of the first one-way valve is disposed at the pump body mechanism; and
the valve seat of the second one-way valve is disposed at the valve cover cavity.
